(19) United States
(12) Patent Application Publication
(10) Pub. No.: US 2010/0188024 A1
(43) Pub. Date: Jul. 29, 2010

(54) METHOD OF CALIBRATING A LIGHTING SYSTEM, AND LIGHTING SYSTEM

(75) Inventors: Peter Hubertus Franciscus Deuenberg, S Hertogenbosh (NL); Josephus Adrianus Maria Van Van Erp, Eindhoven (NL); Wido Van Duijneveldt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/670,139

(22) PCT Filed: Jul. 25, 2008
(86) PCT No.: PCT/IB08/52992

§ 371 Date: Jan. 22, 2010

(30) Foreign Application Priority Data
Jul. 31, 2007 (EP) 07113473.8

(51) Int. Cl. H05B 37/02

(52) U.S. Cl. 315/312

(57) ABSTRACT

In a calibration of a lighting system with at least one light source and a light source driver, and a light source driver controller controlling the light source driver, separate components are calibrated separately before combining them. For this purpose, the light source is coupled with a light source memory, the light source is calibrated by determining a light source operational relationship between a light source input parameter and a light source output parameter, and light source control data representative of the light source operational relationship are stored in the light source memory. The light source driver is coupled with a light source driver memory, the light source driver is calibrated by determining a light source driver operational relationship between a light source driver input parameter and a light source driver output parameter, and light source driver control data representative of the light source driver operational relationship are stored in the light source driver memory. After these separate calibrations, the light source is assembled with the light source driver, and the light source driver controller is calibrated on the basis of the light source control data and the light source driver control data read from the light source memory and the light source driver memory. If a sensor is used in the lighting system to sense the light produced by the light source, the sensor is coupled with a sensor memory, the sensor is calibrated by determining a sensor operational relationship between a sensor input parameter and a sensor output parameter, and sensor control data representative of the sensor operational relationship are stored in the sensor memory. After assembling the sensor with the light source and the light source driver, the light source driver controller is calibrated further on the basis of the sensor control data read from the sensor memory.

### FIELD OF THE INVENTION

The present invention relates to a method of calibrating a lighting system, and a lighting system being calibrated according to such method. A lighting system comprises at least one light source, converting electrical energy into light, and at least one light source driver, providing the electrical energy, with suitable characteristics, to the light source(s).

### BACKGROUND OF THE INVENTION

In a lighting system, one color of light can be produced by one or more light sources, or a variety of colors of light can be produced by combining light emitted from different light sources each emitting a different primary color. Different light sources may be of the same or similar type, or may be of different types.

The term “light source” should be understood to include, but not be limited to, any one or more of a variety of radiation sources, such as LED (Light Emitting Diode) based sources (including one or more LEDs), incandescent sources (such as filament lamps or halogen lamps), fluorescent sources, phosphorescent sources, gas discharge sources or lasers.

Such lighting systems are known per se. They are used, inter alia, for general lighting purposes, such as spot lights, flood lights and for large-area direct-view light emitting panels such as applied, for instance, in signage, contour lighting, and billboards. In addition, such lighting systems are used as backlighting of (image) display devices, for example for television receivers and monitors. Such lighting systems can particularly suitably be used as a backlight for non-emissive displays, such as liquid crystal display devices, also referred to as LCD panels, which are used in (portable) computers or (mobile) telephones.

When light sources of distinct primary colors are used for creating a lighting system, a problem of achieving a desired color point with a desired spread in the color point of the lighting system arises. The color point of a light source is normally characterized by the color coordinates or the so-called tristimulus values (x, y, z) according to the CIE 1931 color diagram, known in the art. In addition, the spread in the color point is normally characterized by the so-called “standard deviation of color-matching” (SDCM) according to the so-called MacAdam ellipses, known in the art. By way of example, with a SDCM of approximately 3 color differences are just discernable. The light sources can be light sources of distinct primary colors, such as, for example the well-known red (R), green (G), or blue (B) light sources. In addition, the light source can have, for example, amber or cyan as primary color. These primary colors may be either generated directly by a light source, or may be generated by a phosphor upon irradiance with light from a light source. In the latter case, also mixed colors or white light is possible as one of the primary colors.

Because the optical properties of the light sources change as a function of time, current and temperature, a light source driver controller is employed to obtain and maintain a predetermined color accuracy. In a lighting system, also the properties of driver circuitry for the light sources may change over time, e.g. by temperature and ageing of components. To provide an reproducibility of the light emission of the one or more light sources, it is known in the art to employ a light source driver controller which may use one or more sensors and a color feedback algorithm in order to obtain a high color accuracy. In such systems a sensor may measure, among others, the light distribution of the light sources, the temperature and/or the level of luminous flux of the light sources. The color feedback algorithm, and other logic circuitry is conventionally implemented in the light source driver (micro)controller located near the light source driver, or forming a unit therewith. The color feedback algorithm senses parameters of the light produced by the lighting system, and the light source driver controller controls the light source driver to reproducibly generate the desired color and intensity of the light. In addition, feed forward control systems are employed to manufacture lighting systems with even higher color accuracies.

Different light sources, even from the same type and from the same origin, in practice have different characteristics after their manufacture. In the color feedback algorithm, data must be used representing the characteristics of the emissions from the different light sources, and algorithms based on these data control the light source emissions.

For an accurate color tuneability, the light sources need to be measured (or calibrated), and this data must be supplied to the color feedback algorithm to control a light source driver coupled to the light source. For example, in a lighting system, a light source (such as an LED) may be switched on and off over time by an associated light source driver with a frequency not detectable by the human eye, where a duty cycle is determined by the color feedback algorithm in order to reach a predetermined color point.

Although the light source driver may have sufficient information about each light source present in the lighting system, colors may still deviate from a desired one when light source driver electronics introduces errors not taken into account during the light source calibration.

Therefore, in a conventional manufacturing process, it is required to set up a combined calibration of both the light source(s) and the light source driver(s) to match them to each other at one time and one location. However, this is undesirable for the following reasons.

First, the light source and the light source driver need to be brought to the same location at the same time for combined calibration at some point in the manufacturing process, which requires complex logistics. Second, the light source and the light source driver, after having been calibrated in combination, should continue to form such combination in use of the lighting system, which reduces flexibility and adds costs.

### OBJECT OF THE INVENTION

It is desirable to provide a lighting system in which basically at random different light sources may be combined with different light source drivers, not impairing the calibration process.

### SUMMARY OF THE INVENTION

In an embodiment of the present invention, a method of calibrating a lighting system is provided. The lighting system comprises at least one light source and a light source driver having a light source driver controller controlling the light source driver. The method comprises: coupling the light source with a light source memory; calibrating the light source by determining a light source operational relationship between a light source input parameter and a light source output parameter; storing light source control data representative of the light source operational relationship in the light source memory; coupling the light source driver with a light source driver memory; calibrating the light source driver by determining a light source driver operational relationship between a light source driver input parameter and a light source driver output parameter; storing light source driver control data representative of the light source driver operational relationship in the light source driver memory; assembling the light source with the light source driver; and calibrating the light source driver controller on the basis of the light source control data and the light source driver control data read from the light source memory and the light source driver memory.

In an embodiment of the method of calibrating a lighting system employing a color feedback system using a sensor to sense the light produced by the light source, the method comprises: providing a sensor to sense the light produced by the light source; coupling a sensor with a sensor memory; calibrating the sensor by determining a sensor operational relationship between a sensor input parameter and a sensor output parameter; storing sensor control data representative of the sensor operational relationship in the sensor memory; assembling the sensor with the light source and the light source driver; and calibrating the light source driver controller further on the basis of the sensor control data read from the sensor memory.

Instead of performing a calibration of a lighting system at the combination of one or more light sources with one or more light source drivers, as usual in the prior art, the present invention proposes to separately calibrate the light source(s), the light source driver(s), and the sensor(s), before they are combined to form the lighting system, and activated for the first time. Upon such activation, the control data stored in the respective memories may be read, e.g. by the light source driver controller, or by a separate programming device, and the light source driver controller may be calibrated on the basis of said control data.

At least one of the light source memory, the light source driver memory, and the sensor memory may form a unit with the light source, the light source driver, and the sensor, respectively, so that control data obtained in the calibration of the specific component is stored physically together with the same component. The control data stored in such memory is readily available when components are combined. As an alternative, the control data may be stored in a remote memory, such as a memory of a remote server, where the component and its associated control data in the memory have a corresponding identifier to enable the coupling of the memory with the control data to the associated component. Identifiers stored in the memories of components can also be used in a registration of a particular combination of components.

The claims and advantages will be more readily appreciated as the same becomes better understood by reference to the following detailed description and considered in connection with the accompanying drawings in which like reference symbols designate like parts.

### BRIEF DESCRIPTION OF THE DRAWING

FIG. 1 depicts a diagram of a lighting system in an embodiment of the present invention.

### DETAILED DESCRIPTION OF EXAMPLES

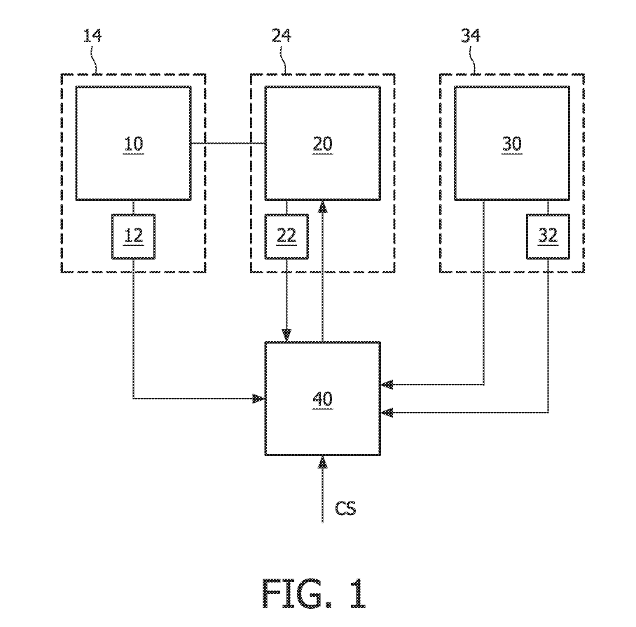

FIG. 1 schematically shows a light source 10, a light source memory 12 coupled to the light source 10 to form a light source unit 14, a light source driver 20, a light source driver memory 22 coupled to the light source driver 20 to form a light source driver unit 24, a sensor 30, a sensor memory 32 coupled to the sensor 30 to form a sensor unit 34, and a light source driver controller 40. A lighting system may comprise at least one light source unit 14, at least one light source driver unit 24, and at least one light source driver controller 40, and may additionally comprise at least one sensor unit 34. The lighting system may be built into a luminary.

The light source memory 12 is configured to store light source data representative of a light source operational relationship between one or more light source input parameters (such as temperature, current) and one or more light source output parameters (such as color point, voltage), where these relationships may also be defined by typical data such as a reference forward current, thermal resistance, hot/cold factor, droop, etc.). The light source driver memory 22 is configured to store light source driver data representative of a light source driver operational relationship between one or more light source driver input parameters (such as a desired color point) and one or more light source driver output parameters (such as a current). The sensor memory 32 is configured to store sensor data representative of a sensor operational relationship between one or more sensor input parameters (such as light of a specified color point) and one or more sensor output parameters (such as a voltage or a current or a code).

Memories may be of an EEPROM (Electrically Erasable Programmable Read Only Memory) type or any other non-volatile type of memory.

In any one of the light source memory 12, the light source driver memory 22, and the sensor memory 32, appropriate control data is written in a calibration process, thus defining the different relevant input/output parameter relationships. In accordance with the present invention, each of the light source 10, the light source driver 20 and the sensor 30 may be calibrated independently (i.e. independent in time and/or location of calibration) from any of the other ones. The light source memory 12 need not be physically coupled to the light source 10 (although it may be), but may also be “virtually” coupled to the light source 10 by being a (designated part of a) memory physically being located at a different location, such as a remote location, or physically being combined with another device, such as the light source driver memory 22. In such a situation, the light source 10 and the light source memory 12 may have a corresponding identifier serving to identify said associated memory or memory part. The same applies to the coupling between the light source driver 20 and the associated light source driver memory 22, and to the coupling between the sensor 30 and the associated sensor memory 32, such couplings being symbolized in FIG. 1 by dotted lines. In brief, the light source 10 and the light source memory 12 form a physical or virtual unit in that one relates to the other. The same applies to the light source driver 20 relating to the light source driver memory 22, and to the sensor 30 and the sensor memory 32, as symbolized in FIG. 1 by dashed boxes.

In a manufacturing processing, each of a light source 10, a light source driver 20, and a sensor 30 may be manufactured separately and independently from the other. Further, a calibration of each of a light source 10, a light source driver 20 and a sensor 30 may be performed separately and independently (in time and location) from the other to generate appropriate light source control data, light source driver control data, and sensor control data.

Once the light source 10 and the light source driver 20 are combined with each other (connected to each other) and activated for the first time, the light source control data from the light source memory 12 is combined and matched with the light source driver data from the light source driver memory 22, and possibly also with the sensor control data (if a sensor 30 forms part of the application) from the sensor memory 32, by the light source driver controller 40. Deviations between reference and actual parameter values may then be compensated for by the light source driver controller 40. Thus, a “calibration” of the lighting system as a whole may take place automatically when combining components on the basis of the control data stored for the components. As a result, when a control signal CS is input to the light source driver controller 40, the lighting system provides the required type and amount of light. The light source driver controller 40 may be physically part of the light source driver unit 24.

A similar “calibration” process of a lighting system as a whole may be performed after disassembling an existing lighting system, and using components to form a new lighting system having combinations of one or more previously used light sources, one or more light source drivers, and possibly one or more sensors. If deemed necessary, each of the previously used light sources, light source drivers or sensors may be recalibrated separately and independently before assembling the new lighting system.

When combining separately calibrated light sources with separately calibrated light source drivers and separately calibrated sensors, it is assumed that no substantial change of components has taken place in the time period between calibration and combination.

In a calibration of an LED light source, light source control data may include forward voltage, tristimulus values, flux and chromaticity, reference temperature, reference forward current, thermal resistances, hot/cold factor, droop, etc.

In a calibration of an LED light source driver, light source driver control data may include forward current, rise and fall times, electrical circuit data, PWM (Pulse Width Modulation) frequencies, etc.

Feedback algorithms in a sensor circuit may include FFB (Flux FeedBack), CCFB (Color FeedBack), combinations thereof with TFF (Temperature Feed Forward), etc.

As required, detailed embodiments of the present invention are disclosed herein. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

1. A method of calibrating a lighting system comprising at least one light source and a light source driver having a light source driver controller controlling the light source driver, the method comprising:
coupling the light source with a light source memory;
calibrating the light source by determining a light source operational relationship between a light source input parameter and a light source output parameter;
storing light source control data representative of the light source operational relationship in the light source memory;
coupling the light source driver with a light source driver memory;
calibrating the light source driver by determining a light source driver operational relationship between a light source driver input parameter and a light source driver output parameter;
storing light source driver control data representative of the light source driver operational relationship in the light source driver memory;
assembling the light source with the light source driver; and
calibrating the light source driver controller on the basis of the light source control data and the light source driver control data read from the light source memory and the light source driver memory.

2. The method according to claim 1, further comprising:
providing a sensor to sense the light produced by the light source;
coupling a sensor with a sensor memory;
calibrating the sensor by determining a sensor operational relationship between a sensor input parameter and a sensor output parameter;
storing sensor control data representative of the sensor operational relationship in the sensor memory;
assembling the sensor with the light source and the light source driver; and
calibrating the light source driver controller further on the basis of the sensor control data read from the sensor memory.

3. A lighting system, comprising:
at least one light source;
a light source memory coupled to the light source, and configured to store light source control data representative of a light source operational relationship between a light source input parameter and a light source output parameter;
a light source driver;
a light source driver memory coupled to the light source driver, and configured to store light source driver control data representative of a light source operational relationship between a light source driver input parameter and a light source driver output parameter;
a light source driver controller coupled to the light source driver, and controlling the light source driver, the light source driver controller being configured to access the light source memory and the light source driver memory, and to control the light source driver on the basis of the light source control data and the light source driver control data read from the light source memory and the light source driver memory.

4. The lighting system according to claim 3, further comprising:
a sensor to sense the light produced by the light source;
a sensor memory coupled the sensor, and configured to store sensor control data representative of a sensor operational relationship between a sensor input parameter and a sensor output parameter,
the light source driver controller being further configured to access the sensor memory, and to control the light source driver on the basis of the light source control data, the light source driver data, and the sensor control data read from the sensor memory.

5. The lighting system according to claim 3, wherein the light source memory forms a unit with the light source.

6. The lighting system according to claim 3, wherein the light source driver memory forms a unit with the light source driver.

7. The lighting system according to claim 4, wherein the sensor memory forms a unit with the sensor.

8. The lighting system according to claim 3, wherein at least one of the light source memory and the light source driver memory is remote from the light source and the light source driver, respectively.

9. The lighting system according to claim 4, wherein the sensor memory is remote from the sensor.
